(19) United States
(12) Patent Application Publication
(10) Pub. No.: US 2013/0084042 A1
(43) Pub. Date: Apr. 4, 2013

(54) DAMAGE RESISTANT FIBER OPTIC CONNECTOR

(71) Applicants: Kevin G. Bouchard, Bristol, CT (US); Mark T. Zmurko, Winsted, CT (US); Bradley Gould, Evanston, IL (US)

(72) Inventors: Kevin G. Bouchard, Bristol, CT (US); Mark T. Zmurko, Winsted, CT (US); Bradley Gould, Evanston, IL (US)

(73) Assignee: OFS Fitel, LLC, Norcross, GA (US)

(21) Appl. No.: 13/401,612

(22) Filed: Feb. 21, 2012

Related U.S. Application Data
(60) Provisional application No. 61/541,175, filed on Sep. 30, 2011.

(51) Int. Cl. G02B 6/36; B23P 11/00

(52) U.S. Cl. 385/78; 385/79; 29/428

(57) ABSTRACT

A fiber optic connector has a connector body, an elongated ferrule supported in the connector body, and a sleeve fixed on the circumference of a distal tip of the ferrule. The ferrule has an axial passage that opens on a front surface of the tip so that an endface of a fiber retained in the passage is exposed at the front surface. Further, the sleeve has a leading edge that projects a determined distance axially beyond the front surface of the tip to form a recessed region in which the exposed endface of the fiber is set back from the leading edge of the sleeve. A barrier is contained in the recessed region for protecting the fiber endface from damage by surrounding objects. The barrier may include a cured epoxy layer, a lens, or a refractive index matching material optically aligned with the fiber endface.

### CROSS REFERENCE TO RELATED APPLICATION

This application claims priority under 35 U.S.C. Section 119(e) of U.S. Provisional Patent Application No. 61/541,175 filed Sep. 30, 2011, entitled “Recessed Ferrule” which is incorporated by reference in its entirety.

### BACKGROUND OF THE INVENTION

1. Field of the Invention

The present invention relates generally to optical connectors, and particularly to an optical fiber connector construction and method of assembling same.

2. Discussion of the Known Art

Currently, most fiber optic connectors lack means for preventing ambient dirt and debris from depositing on a fiber endface that remains exposed at the tip of the connector while the connector is not in use. Such deposits will attenuate light signals transmitted through the connector when the connector is used in a fiber optic network. One known protective measure is to provide a removable end cap for the connector tip. Notwithstanding, persons forget or simply don't bother to place the cap over the connector tip while the connector is out of service. In addition, the cap is often misplaced or inadvertently discarded. As long as the connector remains disengaged from a mating connector or adaptor with the end cap removed, the exposed fiber endface is subject to damage especially while the connector is being handled or cleaned. Moreover, the risk of damaging fibers with extremely small diameters is very high since only a small amount of debris or a relatively small chip can block or damage a larger portion of the fiber.

A connector available from Diamond or Senko and known as type E-2000 has a spring-loaded cap that is attached to the body of the connector. This is a relatively expensive mechanical solution, however, and is difficult to retrofit on the existing standard fiber optic connectors such as types ST and SMA.

Other known solutions involve the formation of an airwell about the fiber endface for high power applications. See, e.g., U.S. Pat. No. 7,431,513 (Oct. 7, 2008) which is incorporated by reference. In the configuration of the '513 patent, a fiber protrudes from an epoxy/connector interface, and the endface of the fiber is either aligned with the open end of the connector's airwell, or is slightly recessed from the open end. These connectors may be of either the epoxy-polish type or the crimp and cleave type, or a combination thereof. The connectors are prefabricated, and each type has drawbacks during its assembly, for example, debris entrapment, poor finish quality, and/or difficult processing steps including polishing and cleaning.

### SUMMARY OF THE INVENTION

According to the invention, a fiber optic connector includes a connector body, an elongated ferrule supported in the connector body, wherein the ferrule has a distal tip, and an axial passage that opens on a front surface of the tip so that an endface of a fiber retained in the passage is exposed at the front surface of the tip, and a sleeve fixed on the circumference of the distal tip of the ferrule. The sleeve has a leading edge that projects a determined distance axially beyond the front surface of the tip to form a recessed region in which the endface of the fiber is set back from the leading edge of the sleeve. A barrier is disposed in the recessed region for protecting the endface of the fiber from damage by surrounding objects. In the disclosed embodiments, the barrier may be in the form of a hardened epoxy layer, a lens, or a refractive index matching material optically aligned with the fiber endface.

For a better understanding of the invention, reference is made to the following description taken in conjunction with the accompanying drawing and the appended claims.

### BRIEF DESCRIPTION OF THE DRAWING

In the drawing:

FIG. 1 is a sectional view of a first embodiment of the inventive fiber optic connector, as seen in a plane containing an axis of the connector;

FIGS. 2(a) and 2(b) are diagrams of test measurement setups used to evaluate the performance of the connector;

FIG. 3 is a sectional view of a second embodiment of the inventive connector, as seen in a plane containing the axis of the connector;

FIG. 4 is an optical diagram illustrating light coupling between the inventive fiber optic connector and a standard connector;

FIG. 5 is a diagram of light throughput through the inventive connector relative to a standard connector without butt coupling of mating fibers; and

FIG. 6 is a diagram of light throughput through the inventive connector relative to a standard connector with butt coupling of mating fibers.

### DETAILED DESCRIPTION OF THE INVENTION

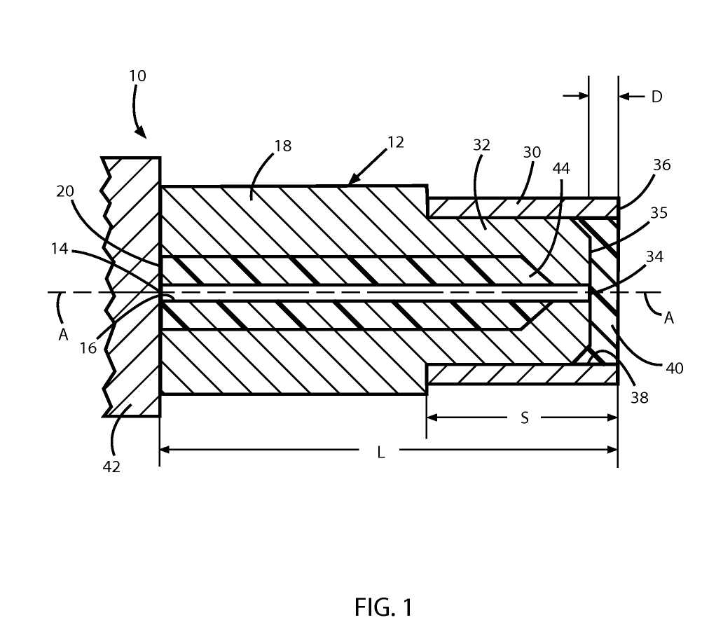

FIG. 1 is a partial cross-sectional view of an optical fiber connector 10 according to the invention, as viewed in a plane containing an axis A of the connector. The connector 10 has a distal end portion 12, and is constructed and arranged to terminate a fiber 14 that is retained in an axial passage 16 through an elongated connector ferrule 18. A distal end of the ferrule 18 defines the end portion 12 of the connector.

The fiber 14 is retained inside the connector 10 in a conventional manner, either by bonding the fiber 14 to the periphery of the ferrule passage 16 using, e.g., a Type 353 epoxy compound at 20, or by crimping the ferrule 18 about the circumference of the fiber 14. The overall construction of the connector 10 may resemble, for example, that of a commercially available SMA 905 fiber optic connector but with certain modifications as detailed below. SMA type fiber optic connectors are generally disclosed in, e.g., U.S. Pat. No. 4,204,306 (May 27, 1980); U.S. Pat. No. 4,440,469 (Apr. 3, 1984); and U.S. Pat. No. 6,953,288 (Oct. 11, 2005), all of which are incorporated by reference.

According to the invention, a sleeve 30 is press fit or otherwise fixed on the circumference of a distal tip 32 of the connector ferrule 18, after an exposed endface 34 of the fiber 14 is polished flush with a front surface 35 on the tip 32 of the ferrule in a known manner. The sleeve 30 may be cut, for example, from a length of stock stainless steel hypodermic tubing. The sleeve 30 may also be cut from other commercially available metal tubing including aluminum, titanium, or brass; or from tubing made of a plastics material.

In the embodiment of FIG. 1, the outer diameter of the ferrule tip 32 is preferably turned down from that of the adjacent portion of the ferrule 18 before the sleeve 30 is applied, so that the outer circumference of the sleeve 30 does not extend radially beyond that of the adjacent portion of the ferrule. Further, the sleeve 30 has a final length S such that a leading or distal edge 36 of the sleeve projects a certain distance D axially beyond the front surface 35 of the ferrule tip 32, thus forming a recessed region 38 in which the entire ferrule tip 32 is set back from the leading edge 36 of the sleeve 30. Because the exposed endface 34 of the fiber 12 is also set back from the leading edge 36 of the sleeve 30, surrounding objects that would otherwise damage the fiber endface 34 are blocked by the leading edge 36 from direct contact with the fiber endface. For added protection, the recessed region 38 is preferably filled with an optically transparent epoxy to form a barrier layer 40 between the fiber endface 34 and the leading edge 36 of the sleeve 30. See the Examples below.

To assemble the connector 10 in FIG. 1, a rear portion of the ferrule 18 is pressed or otherwise fixed by conventional means inside of a body 42 of the connector by such an amount so that when a length of the tubing forming the sleeve 30 is press fit or otherwise secured on the ferrule tip 32 and the sleeve 30 is cut back and polished, the overall length L between the leading edge 36 of the sleeve 30 and the body 42 of the connector measures, for example, 0.3862 inch which is the prescribed length of a ferrule tip on a standard type SMA 905 optical connector. The distances provided in the Examples below are based on achieving a thickness D of 0.007 inch (or 183 to 184 μm) for the barrier layer 40.

Before mounting the sleeve 30, the front surface 35 of the ferrule 18 is polished back toward the connector body 42 along with the fiber endface 34 exposed on the front surface 35, until the front surface 35 projects axially from the connector body 42 by 0.3792 inch (0.3862 in. −0.007 in.). Next, the sleeve 30 having an initial oversized length of about 0.250 inch is cut from, e.g., No. 304 stock stainless steel hypodermic tubing. One open end of the sleeve is press fit onto the circumference of the ferrule tip 32. The opposite open end of the sleeve 30 is filled with epoxy compound, e.g., Epotek 301-2 and the compound is allowed to cure. The sleeve 30 is then polished back toward the connector body 42 with the contained hardened epoxy until the leading edge 36 of the sleeve is at a distance L=0.3862 inch from the connector body 42. It is preferred that the front surface 35 of the ferrule tip not be polished so far as to extend into a chamfer 44 that is typically formed at the distal end of the axial passage 16 inside the ferrule 18. One reason to avoid polishing into the chamfer 44 is to minimize the physical size of the epoxy boundary that is subject to increased debris entrapment and voids, leading to a poor polish quality.

### EXAMPLE ONE

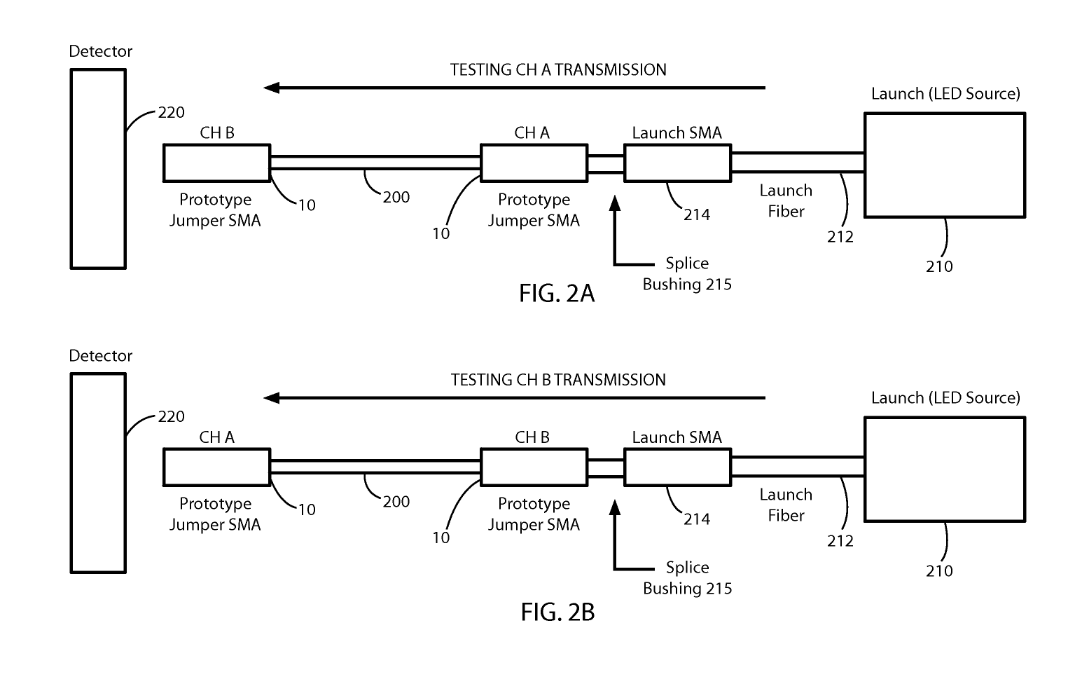

FIGS. 2(a) and 2(b) show transmission test measurement set-ups for the inventive connector 10 in FIG. 1. An approximately one meter length of a 50 μm/60 μm/70 μm glass/glass/polyimide fiber 200 (available from, e.g., Polymicro) is terminated at each end by a connector 10 constructed according to the invention. For the purpose of each set-up, the exact length of the fiber 200 is not critical. The refractive index (RI) of the fiber core is 1.46, and the RI of the epoxy barrier 40 formed at the end of the ferrule tip 32 of the connector 10 (see FIG. 1) is 1.53. In FIGS. 2(a) and 2(b), CH A connotes one of the inventive connectors 10 at one end of the fiber 200, and CH B connotes the other connector 10 at the opposite end of the fiber.

The output of a LED light source 210 (e.g., WT&T Model LE-IG-C) is coupled to one end of a launch fiber 212, the other end of which terminates in a standard “launch” SMA connector 214. In FIG. 2(a), the CH A connector 10 at the right end of the fiber 200 is connected to a “splice bushing” 215 which is a standard adapter for mating the SMA connector 214 at the end of the launch fiber 212 with the CH A connector 10 under test. In FIG. 2(b), the CH B connector 10 is connected for testing to the splice bushing 215. A light detector 220 (e.g., Ophir Model PD300R from Nova Display) is arranged to measure light transmitted from the source 210, through the connector 10 under test connected to the splice bushing 215, the fiber 200, and out of the other connector 10 at the opposite end of the fiber 200. Persons skilled in the art will understand that the latter connector 10 has relatively little influence on the light measurement assuming it is not grossly damaged. This is because the entire “content” of light is dumped out of the latter connector 10 at the detector 220, and the light is received by the detector operating as a “bucket”.

Table 1 below shows test measurement results obtained for the CH A connector 10 in FIG. 2(a), and for the CH B connector 10 in FIG. 2(b). After the ferrule tip 32 of each connector 10 was polished back to a “shortened” length so as to extend 0.3792 inch from the connector body 42, and before fixing the sleeve 30 on the ferrule tip 32, transmission was measured with both of the CH A and the CH B connectors 10 in the shortened ferrule state and before forming the barrier layer 40. The results are set out under the column headed Transmission Pre Epoxy Layer (μW).

Next, a sleeve 30 containing the hardened epoxy compound was placed on the ferrule tip 32 of each connector 10, and the leading edge 36 of each sleeve was polished until the edge was a distance L of 0.3862 inch from the body 42 of the connector. Light transmission through each of the connectors 10 at the ends of the fiber 200 was measured again, and the results appear under the column headed Transmission Post Epoxy Layer (μW).

TABLE 1

| | SMA | Transmission | SMA Final | Transmission |
|---|---|---|---|---|
| Connector | Custom | Pre Epoxy | Length (w/ | Post |
| Under | Polish | Layer | Epoxy layer) | Epoxy |
| Test - CH | Length | (μW) | (0 μm /−20 μm) | Layer (μW) |
| A | −183/−184 μm | 4.38 | −3 | 3.64 |
| B | −183/−184 μm | 4.35 | −1 | 3.68 |

### EXAMPLE TWO

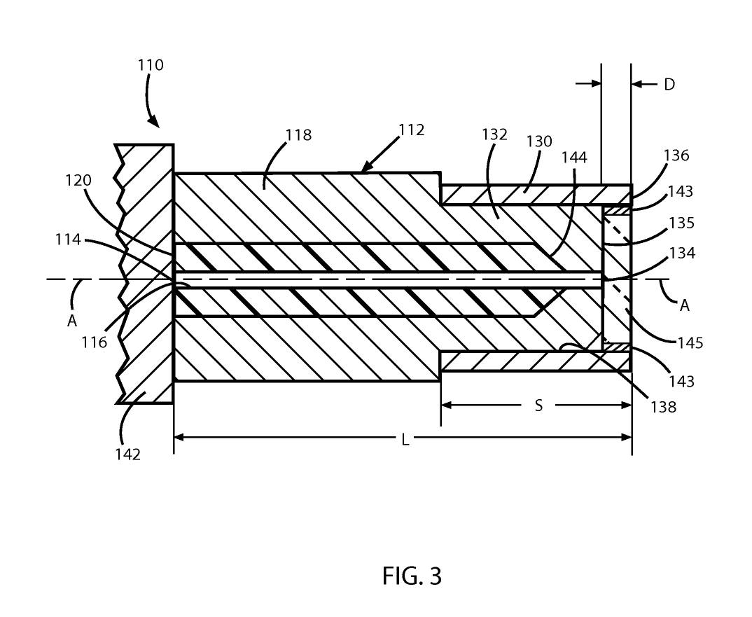

A second test was performed on a lensed version of the inventive connector 10. In FIG. 3, parts of connector 110 that correspond to those of the connector 10 in FIG. 1 have corresponding reference numerals increased by 100.

In this Example, the single fiber 200 in FIGS. 2(a) and 2(b) was terminated at one end with the inventive connector 110, and at the opposite end with a conventional type SMA 905 fiber optic connector. To prepare the connector 110, the ferrule nose of an existing SMA 905 connector having a 77 μm thru-hole ferrule passage 116 was modified by turning down the outside diameter of the ferrule tip 132 from 0.125 inch to 0.085 inch over a length of 0.125 inch from the leading front surface 135 of the tip. The rear portion of the ferrule 118 was then advanced into the connector body 142 until a shoulder length of 0.384 inch between the front surface 135 of the ferrule tip 132 and the connector body 142 was obtained.

One end of the fiber 200 fiber was inserted in the ferrule passage 116 and retained in the body 142 of the inventive connector 110 (CH A). The front surface 135 at the tip of the ferrule 118 was polished back together with the exposed fiber endface 134 to a length of 0.379 inch from the connector body 142 (i.e., 178 μm shorter than the standard 0.3862 inch SMA ferrule tip length). The opposite end of the fiber 200 was terminated in a conventional manner by a regular SMA 905 connector (CH B). Light transmission through the fiber 200 with the connectors at both ends was then measured.

Using “Loctite 4014”, one end of a 0.250 inch length of stock stainless steel hypodermic tubing having an I.D. of 0.085 inch and an O.D. of 0.109 inch, was secured on the ferrule tip 132 of the shortened SMA connector CH A, in axial alignment with the ferrule to form the sleeve 130. The recessed region 138 formed by the sleeve 130 was filled with “Epotek 301-2” epoxy compound 143. A lens rod 145 made of BK7 glass measuring 4.0 mm in length with an O.D. of 2.0 mm, was polished at both ends to a 0.3 μm finish. The lens rod 145 was then advanced axially into the region 138, and a conventional fixture was provided to keep the inwardly facing end of the lens rod 145 in contact with the endface 134 of the fiber 116 on the front surface 135 of the shortened ferrule 118 until the epoxy cured. The sleeve 130 and the distal end of the lens rod 145 were polished back together to a distance L of 0.3862 inch from the connector body 142.

Optical transmission measurements were performed and appear in the last column of Table 2 below, under the heading Transmission Post Epoxy Layer (μW). Some of the measurements varied within expected limits as a function of rotational orientation of the connector under test at the splice bushing 215 in the test setup in FIGS. 2(a) & 2(b). The spectral response for the inventive connector (CH A) was slightly better than that obtained for the regular SMA connector (CH B) over the same fiber 200 in multiple forms of transmission testing.

TABLE 2

| Connec- | | SMA | Transmission | SMA Final | Transmission |
|---|---|---|---|---|---|
| tor CH | | Custom | Pre Epoxy | Length (w/ | Post |
| Under | | Polish | Layer | Epoxy layer) | Epoxy |
| Test | Type | Length | (μW) | (μm) | Layer (μW) |
| A | Invention | −178 | 4.31 | 0 | 3.96/3.66 |
| | | μm | | | |
| B | Regular | n/a | 4.15 | −1 | 4.07/3.92 |

Table 2 shows that when the output of the light source 210 was connected directly to the shortened inventive connector (CH A) under test at one end of the fiber 200, a power level of 4.31 μW was measured by the detector 220 from the standard SMA 905 connector at the opposite end of the fiber 200. When the output of the source 210 was directly applied to the standard SMA 905 connector (CH B), a power level of 4.15 μW was measured by the detector 220 from the inventive connector CH A.

In summary, the measurement results in Table 1 indicate slightly more transmission loss than anticipated under the test conditions, but are satisfactory nonetheless. The measurement results shown in Table 2 are more encouraging, and are very satisfactory for the tested configurations.

Oscillations in the transmissions with respect to wavelength were detected at times. The oscillations are believed to be caused by the fiber/epoxy/lens interfaces, and to have arisen as a result of pressure that was applied to cure the epoxy compound. If persistent, it may be possible to normalize such oscillations by use of software in a known manner. Moreover, the epoxy compound may be cured without a need for applying external pressure. For example, the lens rod 145 may be cured to the fiber end face 135 using a temporary centering fixture, the fixture then removed, and the sleeve 130 installed as a secondary component. This may resolve various issues by providing a uniform stress free-bond between the lens rod 145 and the fiber end face 135, as well as a more uniform bond between the cylindrical surface of the lens rod 145 and the sleeve 130, i.e., no air or voids. Such would also allow for the use of a non-optical epoxy providing greater protection for the bond between the lens rod 145 and the sleeve 130.

It is desirable to minimize or completely eliminate the presence of air bubbles in the epoxy bond between the fiber 16 (or 116), the ferrule tip 32 (or 132) and the sleeve 30 (or 130), with no delamination or noticeable problems. For the most part, air bubbles in the bond between the circumference of the lens rod 145 and the inner diameter of the metal sleeve 130 may be polished through, but should preferably be eliminated entirely to obtain a fully solid epoxy region 143 between the lens rod 145 and the sleeve 130. This will also ensure that the connector 110 is resistant to damage caused by aggressive cleaning chemicals like “CIDEX” that are typically used on optical connectors and assemblies as high level disinfectants in the medical field.

Standard optical SMA connectors are generally configured to be butt-coupled with other optical SMA connectors. There are industry standard female-female couplers which, when fully connected at each end with a male SMA connector, define the spacing between butt coupled fiber end-faces. Normally, there is a small air gap in the fully seated position that allows the fiber endfaces to approach one another very closely without damaging them. The close proximity of the fibers helps to optimize optical coupling efficiency since it prevents diverging light from becoming lost from the coupling fiber.

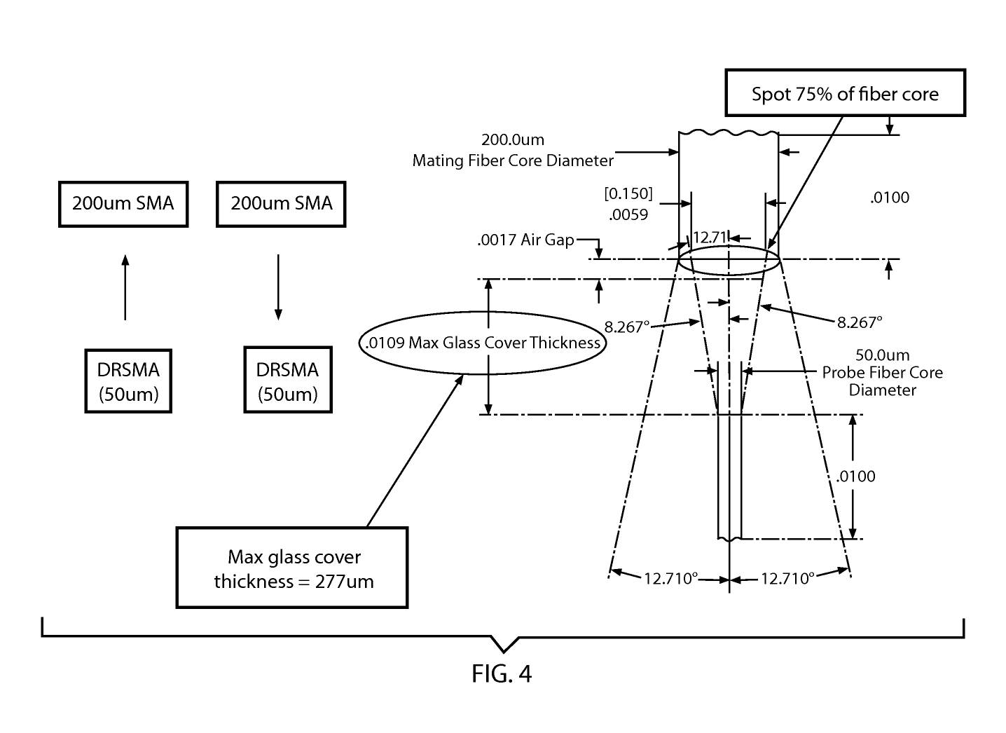

With the inventive damage resistant SMA connector construction, the fiber endface is slightly recessed and shielded behind an epoxy or glass barrier. The optics diagram of FIG. 4 illustrates a 50 um fiber having a numerical aperture (NA) of 0.22 terminated in the inventive DRSMA connector 10, when butt coupled to another 200 um, 0.22 NA fiber. As shown in FIG. 4, no additional coupling losses are introduced by the connector 10 relative to a standard SMA-SMA connector coupling.

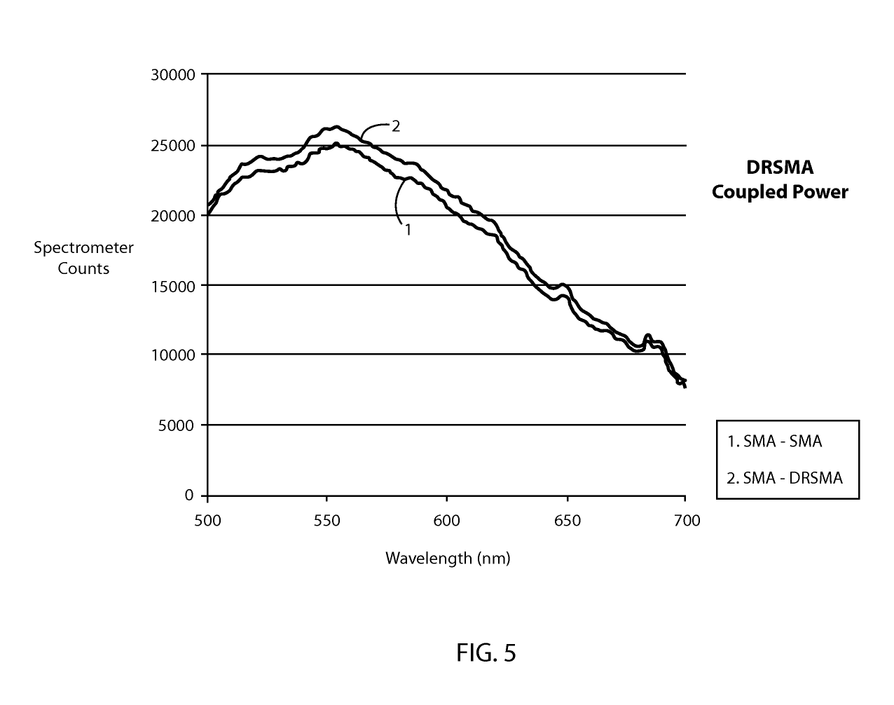

FIG. 5 shows a measured power spectrum, not butt coupled, for the following two configurations. The figure shows minimal spectral effects and relative throughput of the inventive DRSMA connector 10 relative to standard optical SMA connectors, without butt coupling of any mating fibers.

Curve 1—HPX2000 Xenon Light source→SMA connector of patch→Patch fiber→SMA connector of patch→Integrating sphere→usb2000+spectrometer→CPU.

Curve 2—HPX2000 Xenon Light source→SMA connector of patch→Patch fiber→DRSMA connector 10 of patch→Integrating sphere→usb2000+spectrometer→CPU.

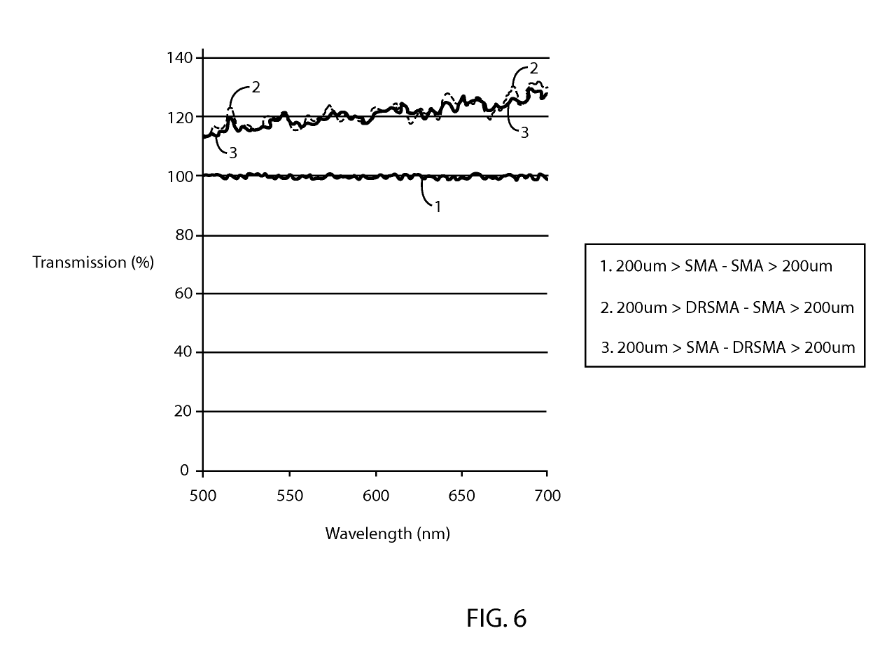

FIG. 6 shows a measured power spectrum, butt coupled, for the following three configurations. The figure shows minimal spectral effects and high coupled throughput of the DRSMA connector 10 relative to standard optical SMA connectors with butt coupling of mating fibers on each direction of the DRSMA patch.

Curve 1—HPX2000 Xenon Light source→200 um, 0.22 NA Patch cord→SMA connector of patch-SMA connector of patch→200 um, 0.22 NA patch→Integrating sphere→usb2000+spectrometer→CPU.

Curve 2—HPX2000 Xenon Light source→200 um, 0.22 NA Patch cord→DRSMA connector 10 of patch-SMA connector of patch→200 um, 0.22 NA patch→Integrating sphere→usb2000+spectrometer→CPU.

Curve 3—HPX2000 Xenon Light source→200 um, 0.22 NA Patch cord→SMA connector of patch-DRSMA connector 10 of patch→200 um, 0.22 NA patch→Integrating sphere→usb2000+spectrometer→CPU.

According to the invention, the recessed region 38 (or 138) is formed between the fiber endface 34 (or 134) and the distal edge 36 (or 136) of the sleeve 30 (or 130). In the embodiment of FIG. 1, the region 38 is filled entirely with an epoxy compound that safeguards the fiber endface 34 by forming a solid barrier 40 over the endface after the sleeve 30 is filled with the compound, and the compound is cured and polished. The hardened epoxy barrier 40 can be easily reworked if it becomes scratched.

In the embodiment of FIG. 3, a lens rod 145 is supported in the recess 138 next to the fiber endface 134 by an epoxy or similar compound so that light signals input to or output from the fiber 114 can be altered as desired. A suitable glass for such a lens is, for example, BK7 having a RI of 1.52. Alternatively, the recessed region 38 may contain a refractive index matching material in contact with the fiber endface 34. Moreover, the length of the recessed region 38 or 138 may possibly vary between 0.001 inch and 0.385 inch, and realistically between 0.003 inch and 0.375 inch, depending on the application.

While the foregoing represents preferred embodiments of the present invention, it will be understood by persons skilled in the art that various modifications and changes can be made without departing from the spirit and scope of the invention, and that the invention includes all such modifications and changes that are within the scope of the appended claims.

We claim:

1. A fiber optic connector, comprising:
a connector body;
an elongated ferrule supported in the connector body, wherein the ferrule has a distal tip, and an axial passage that opens on a front surface of the tip so that an endface of a fiber retained in the passage is exposed at the front surface of the tip;
a sleeve fixed on the circumference of the distal tip of the ferrule, wherein the sleeve has a leading edge that projects a determined distance axially beyond the front surface of the tip to form a recessed region in which the end face of the fiber is set back by said distance from the leading edge of the sleeve; and
a barrier contained in the recessed region for protecting the endface of the fiber from damage by surrounding objects.

2. A connector according to claim 1, wherein the barrier comprises an epoxy compound.

3. A connector according to claim 1, wherein the sleeve comprises a metallic material.

4. A connector according to claim 3, wherein the metallic material comprises stainless steel, aluminum, titanium, or brass.

5. A connector according to claim 1, wherein the sleeve comprises a plastics material.

6. A connector according to claim 1, wherein the connector body and the ferrule are substantially identical to a connector body and a ferrule of a type SMA 905 fiber optic connector.

7. A connector according to claim 1, wherein the leading edge of the sleeve projects between 0.001 inch and 0.385 inch from the front surface of the ferrule tip to form the recessed region.

8. A connector according to claim 1, wherein the leading edge of the sleeve projects approximately 0.007 inch from the front surface of the ferrule tip to form the recessed region.

9. A connector according to claim 1, wherein the leading edge of the sleeve is located approximately 0.3862 inch from the connector body in the axial direction.

10. A connector according to claim 1, wherein the leading edge of the sleeve projects approximately 0.007 inch from the front surface of the ferrule tip to form the recessed region, and the leading edge is located approximately 0.3862 inch from the connector body in the axial direction.

11. A connector according to claim 1, wherein the barrier comprises a lens that is optically aligned with the endface of the fiber.

12. A connector according to claim 11, including an epoxy compound for fixing the lens inside the recessed region.

13. A connector according to claim 1, wherein the barrier comprises a refractive index matching material that is optically aligned with the endface of the fiber.

14. A method of assembling a fiber optic connector, comprising:
providing a connector body;
inserting an elongated ferrule in the connector body, and retaining an optical fiber in an axial passage through the ferrule so that an endface of the fiber is exposed on a front surface of a distal tip of the ferrule;
fixing a sleeve on the circumference of the distal tip of the ferrule so that a leading edge of the sleeve projects a determined distance axially beyond the front surface of the tip, thus forming a recessed region in which the endface of the fiber is set back by said distance from the leading edge of the sleeve; and
containing a barrier in the recessed region for protecting the endface of the fiber from damage by surrounding objects.

15. The method of claim 14, including projecting the leading edge of the sleeve between 0.001 inch and 0.385 inch from the front surface of the ferrule tip to form the recessed region.

16. The method of claim 15, including projecting the leading edge of the sleeve approximately 0.007 inch from the front surface of the ferrule tip to form the recessed region.

17. The method of claim 14, including inserting the ferrule in the connector body so that the distance in the axial direction between the front surface of the ferrule tip and the connector body is approximately 0.3792 inch prior to fixing the sleeve on the tip of the ferrule.

18. The method of claim 17, including locating the leading edge of the sleeve approximately 0.3862 inch from the connector body in the axial direction.

19. The method of claim 14, including providing the barrier in the recessed region in the form of a lens, and optically aligning the lens with the endface of the fiber.

20. The method of claim 19, including using an epoxy compound for fixing the lens inside the recessed region.

21. The method of claim 20, including curing the epoxy compound in the absence of external pressure, thus reducing or eliminating the presence of air bubbles in a bond between the lens and the sleeve.

22. The method of claim 14, including providing the barrier in the recessed region in the form of a refractive index matching material, and optically aligning with the material with the endface of the fiber.
